(19) United States
(12) Patent Application Publication
(10) Pub. No.: US 2011/0226023 A1
(43) Pub. Date: Sep. 22, 2011

(54) Key storage lock box

(76) Inventor: Tim Freeman, Lynnwood, WA (US)

(21) Appl. No.: 12/800,596

(22) Filed: May 17, 2010

Related U.S. Application Data
(63) Continuation-in-part of application No. 29/348,373, filed on Dec. 23, 2009, now Pat. No. D615842.

(51) Int. Cl. B65D 55/14; E05B 65/52

(52) U.S. Cl. 70/24

(57) ABSTRACT

A key storage lock box has an internal cavity for storing an item to be stored, such as a residential key. The lock box includes a shackle for selectively connecting the lock box to a doorknob. The lock box includes a pushbutton locking mechanism having alphanumeric codes associated with one or more of the pushbuttons on the keypad.

### CROSS-REFERENCE TO RELATED APPLICATION(S)

This nonprovisional continuation-in-part patent application claims priority from and the benefit of the filing date of copending design patent application Ser. No. 29/348,373 filed Dec. 23, 2009, titled “KEY STORAGE LOCK BOX” by Tim Freeman, assigned to the assignee of the presentation application in accordance with 35 U.S.C. §120. The disclosure of said parent application is incorporated herein by this reference.

### TECHNICAL FIELD

The invention relates to combinated locks. More specifically, the invention relates to key storage lock boxes for residential use having combinations thereon.

### BACKGROUND OF THE INVENTION

A variety of key storage lock boxes are available for use by homeowners engaged in real-estate transactions. Conventionally, such lock boxes consist of a shackle-like device large enough to fit around a shank portion of a doorknob but insufficiently large to slip over the doorknob itself. The shackle is selectively locked into a box-like structure having a cavity therein for receipt of a residential entryway or house key. The cavity is sealed typically by a removable, slideable or pivotal door, which itself is secured to the lock box with a master key. Realtors, in particular, may be provided with a master key to open the lock box, thereby removing the house key. A separate key is typically necessary for decoupling the shackle from the box so as to remove the lock box from the residential doorknob. Additional versions of lock boxes are available in which the cavity for storing the residential key is accessed through a combinated rotary tumbler system. That is, dialing the correct combination on the rotary tumblers releases the door to the cavity through which access to the internally stored residential key or keys can be obtained. Again, operation of the shackle to remove the lock box from the residential doorknob is achieved by a way of a separate master key or separate locking system.

Less than one year prior to the filing date of this application, the assignee of the present invention sold, and offered for sale a combinated key lock box having a keypad lock for accessing the internal storage cavity. The keypad contained a plurality of numbers 1 through 9 to provide a sequentially accessed combination. Upon entry of the correct sequence of numbers, the keypad door opens, allowing access to the internal cavity. A separate internal latch permits the shackle to be disengaged from the doorknob.

Devices of the type described above are commercially available at www.shurlok-products.com under the brand name “Shurlok”.

Thus, a variety of products are available within the genre of key storage lock boxes for residential real estate purposes to meet various needs. Nevertheless, recalling a numeric code, or a variety of numeric codes for different lock boxes at different residences, may be cumbersome. Therefore, a need exists for a key storage lock box offering multiple mnemonic methods for recalling a combination.

### BRIEF SUMMARY OF THE INVENTION

It is therefore an object of the present invention to provide a key storage lock box having additional means beyond a numeric security code for combinating a lock box.

The invention achieves the above object and other objects and advantages that will become apparent from the description that follows, by providing a combinated key lock box having a plurality of pushbutton keys for operating a combination. In the preferred embodiment of the invention, the keypad is laid out in a fashion similar to a telephone touchpad. In this preferred embodiment, the keypad includes both alpha and numeric symbols, such that a combination can be remembered phonetically, in addition to or in combination with numeric codes. The lock box is preferably of the type having a main body defining an internal cavity for an item to be stored therein, such as a conventional residential house key. A movable shackle is preferably connected and selectively operable with respect to the main body. The main body supports a door connected thereto in a movable fashion, such as a pivotal connection. The door preferably substantially seals the cavity and carries the pushbutton-operated combination lock. The door has a faceplate including a keypad having plurality of alpha and numeric characters closely associated with selected pushbuttons. The door may also conceal a latch mechanism for operating the shackle, thereby allowing anyone with the correct combination to not only open the door and gain access to the residential key, but also to remove the lock box from the door.

### BRIEF DESCRIPTION OF THE DRAWINGS

FIG. 1 is an isometric, perspective view of a lock box in accordance with the principles of the invention having a door pivotally connected to a lock box in an open position;

FIG. 2 is an isometric, perspective view similar to FIG. 1 in which the door containing a keypad is shown in the open position, revealing an internal cavity of the lock box;

FIG. 3 is a front elevational view of the lock box shown in FIG. 1;

FIG. 4A is a rear view of the door having the keypad, showing means for setting a combination for the keypad; and

FIG. 4B is a schematic view of the lock box internal cavity illustrating a latch for releasing he shackle.

### DETAILED DESCRIPTION OF THE PREFERRED EMBODIMENTS

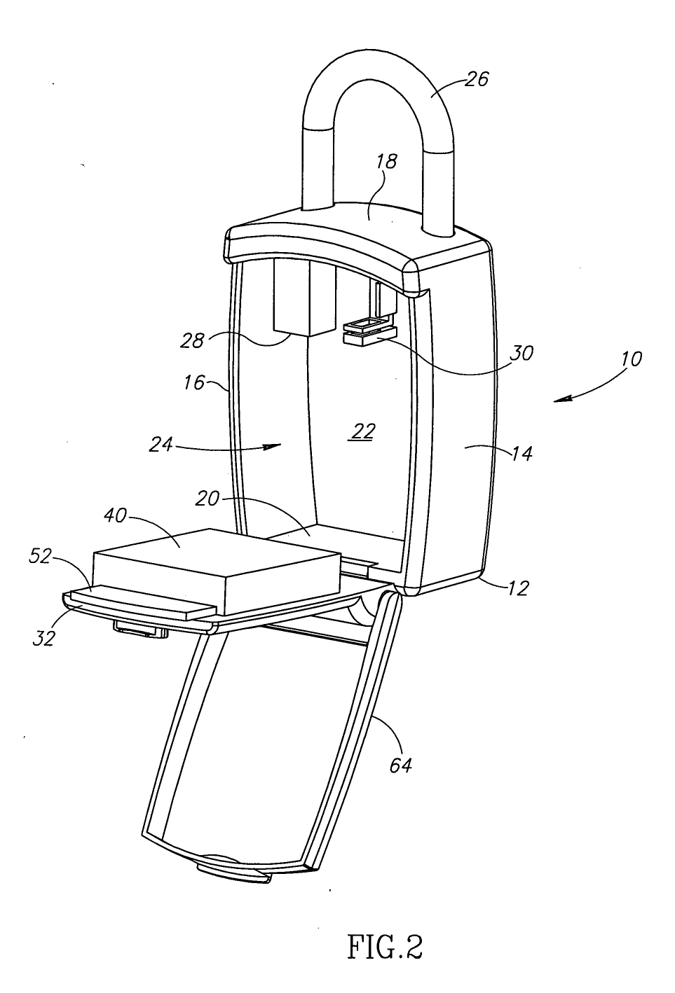

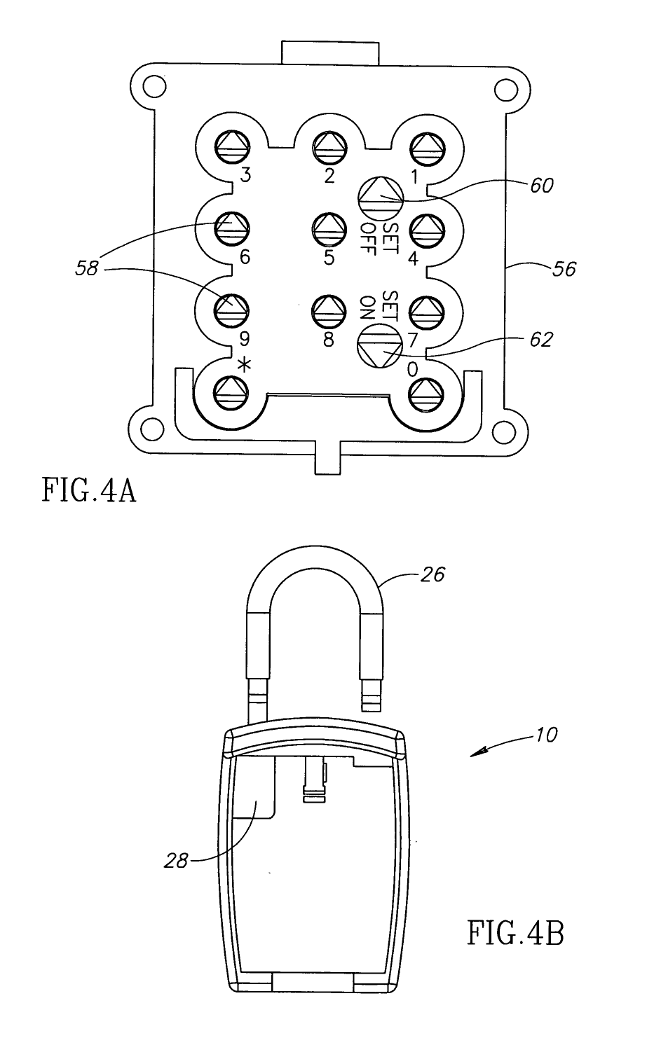

A key storage lock box in accordance with the principles of the invention is generally indicated at reference numeral 10 in the various FIGURES of the attached drawings, wherein numbered elements in the FIGURES correspond to like numbered elements herein. The lock box includes a main body having laterally disposed, spaced-apart, elongated sidewalls 14, 16, a spaced apart top wall 18, a bottom wall 20, and a rear wall 22, all defining an internal cavity generally indicated at reference numeral 24, for storing an item to be stored, such as a conventional residential entryway key or the like. A generally U-shaped shackle 26 is connected to the top wall 18 in the conventional manner so as to be selectively lockable therewith and releasable therefrom with a conventional locking mechanism 28. As will be well understood by those of ordinary skill in the art, a sliding shackle release 30 is operable by a lateral movement for releasing the shackle from the top wall 18, as shown in FIG. 4B and thus from the doorknob. As best seen in FIG. 2, the key storage lock box 10 includes a door 32, which is pivotally connected to the bottom wall 20 of the lock box. The door operates to selectively reveal or conceal the internal cavity 24 in a locking manner. The door includes a conventional keypad locking mechanism 40 having a plurality of pushbuttons 44 arranged in a conventional telephone dialing pad configuration. Combination numbers 1 through 9, a zero, and asterisk (*) are provided on a faceplate 46 in the conventional manner. A “clear” button 48 is provided with the locking mechanism 40 so as to protrude through the faceplate 46, whereby the operator can clear the selected pushbuttons. The “clear” button allows a user to clear an improperly entered combination.

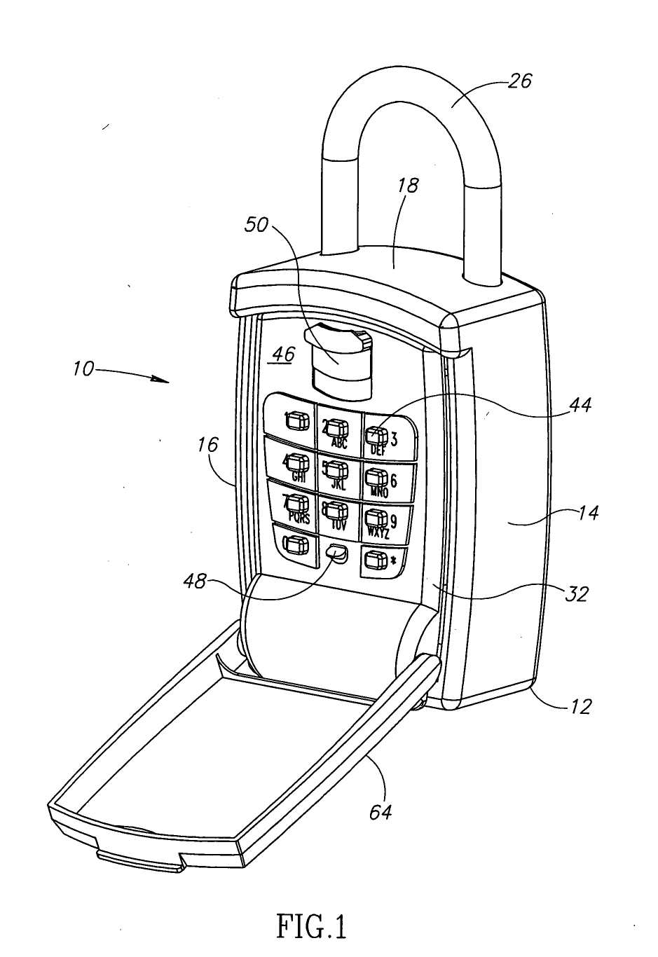

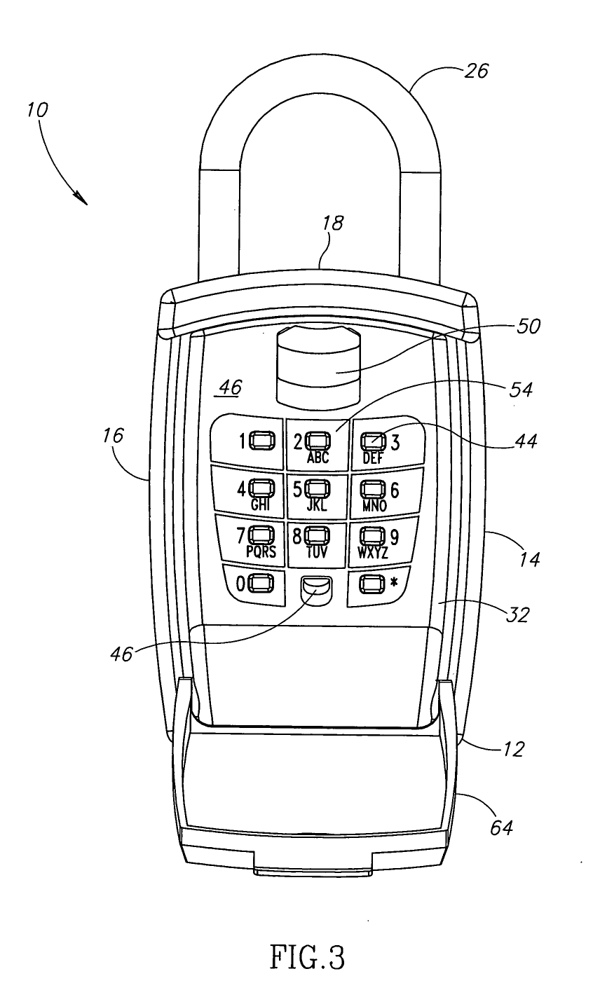

As best seen in FIGS. 1 and 3, an open tab 50 is provided so as to also penetrate the faceplate 46, allowing a user to open the door 32 whenever the correct combination is entered on the pushbuttons 44 in the correct sequence. The tab 50 is operably connected to an internal latch 52, best seen in FIG. 2, which cooperates with a groove (not shown) in the top wall 18 so as to secure the door with respect to the lock box in the closed position shown in FIGS. 1 and 3.

In addition to the conventional numerical indicia provided on the faceplate 46, the invention provides additional indicia for remembering a combination for the lock box 10. In the preferred embodiment, the additional indicia are in the form of alpha characters in the category of alphanumeric code, best seen in FIG. 3, associated with one or more of the pushbuttons 44. By way of example and not limitation, in the preferred embodiment, as shown in FIG. 3, the alpha characters “a, b, c” are associated with pushbutton No. 2, shown at reference numeral 54. The alpha characters “d, e, f” are associated with numerical pushbutton 3, and the alpha characters “g, h, i” are associated with numerical pushbutton 4, et cetera. The 26 letters of the English alphabet are therefore associated with numeric pushbuttons 2 through 9. Pushbutton No. 1, pushbutton 0, and the pushbutton for the asterisk keypad are not associated with any alpha characters. Those of ordinary skill in the art will appreciate that a user, such as a realtor, can now remember an alpha, and/or alphanumeric, code for a certain residence. For example, the Smith house at No. 13 Oxford Lane could be remembered as “Smith13”. It is well established that such alphanumeric codes are far easier to remember than purely numeric codes. Furthermore, as there are only eleven pushbuttons on a keypad of this type, only words with less than eight nonrepeating letters may be used. Thus, it is advantageous to use both alpha and numeric characters for mnemonic purposes.

The keypad locking mechanism 40 includes a conventional coding device best seen in FIG. 4A, illustrating the rear side 56 of the locking mechanism 40. The coding device consists of a series of triangular knobs 58 that may be set in a binary position to an ON or OFF position. Set OFF knob 60 and set ON knob 62 are provided in a conventional fashion to store a combination. By way of example, the sequence of knob positions, shown in FIG. 4A sets a sample combination of 1965. This can be remembered as “1zol”, which may be easier to remember than “1965”.

Those of ordinary skill in the art will conceive of other alternate embodiments of the invention upon reviewing this disclosure. For example, the door 32 may be provided with a pivotally attached cover 64 for covering up the keypad and protecting the same from the ambient conditions, such as rain. Additionally, the alphanumeric codes could be placed on the pushbuttons 44 rather than the faceplate 46, or both. Thus, the invention is not to be limited to the above description, but is to be determined in scope by the claims, which follow.

I claim:

1. A key lock box, comprising:
a main body defining an internal cavity for an item to be stored therein;
a movable shackle connected to and selectively operable with respect to the main body; and,
a door, pivotally connected to the main body and configured to selectively seal the cavity, the door having a pushbutton-operated combination lock operatively connected to a door releasing latch, the combination lock having a faceplate including a keypad having a plurality of alphanumeric characters closely associated with a plurality of the pushbuttons.

2. The lock box of claim 1, wherein the shackle is operatively connected to and operable in response to actuation of the combination lock.

3. The lock box of claim 1, wherein the cavity is sized to receive a conventional residential entryway key.

4. The lock box of claim 1, including a cover pivotally connected to the door for selectively covering the keypad and the latch.

5. A key lock box, comprising:
a main body defining an internal cavity;
a movable shackle connected to the main body; and,
a door, pivotally connected to the main body for sealing the cavity; and,
a pushbutton-operated combination lock operatively connected to the door, the combination lock having a faceplate including a keypad having a plurality of alphanumeric characters closely associated with a plurality of the pushbuttons.

6. The lock box of claim 5, wherein the shackle is operatively connected to and operable in response to actuation of the combination lock.

7. The lock box of claim 5, wherein the cavity is sized to receive a conventional residential entryway key.

8. The lock box of claim 5, including a cover pivotally connected to the door for selectively covering the keypad.

9. The lock box of claim 5, including a cover pivotally connected to the lock box for selectively covering the keypad and latch.

10. A key lock box, comprising:
a main body defining an internal cavity for an item to be stored therein; and,
a door, pivotally connected to the main body and configured to selectively seal the cavity, the door having a pushbutton-operated combination lock operatively connected to a door-releasing latch, the combination lock having a faceplate including a keypad having a plurality of alphanumeric characters closely associated with a plurality of the pushbuttons.
